(19) United States
(12) Patent Application Publication
(10) Pub. No.: US 2003/0159282 A1
(43) Pub. Date: Aug. 28, 2003

(54) Wiring board and method of fabricating the same, semiconductor device, and electronic instrument

(75) Inventor: Hideki Yuzawa, Zida-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 10/359,740

(22) Filed: Feb. 5, 2003

(30) Foreign Application Priority Data
Feb. 26, 2002 (JP) 2002-049512

(51) Int. Cl. H01K 3/10

(52) U.S. Cl. 29/852

(57) ABSTRACT

A penetrating hole is formed by punching out part of a region in a conductive pattern supported on a substrate, the region being-covered by a protective film which is provided over the substrate, and the substrate and the protective film being punched out together with the part of the region.

Japanese Patent Application No. 2002-49512, filed on Feb. 26, 2002, is hereby incorporated by reference in its entirety.

### BACKGROUND OF THE INVENTION

The present invention relates to a wiring board and a method of fabricating the wiring board, a semiconductor device, and an electronic instrument.

A known mounting method is chip-on-film (COF) in which semiconductor chips are mounted on tape. An interconnecting pattern is formed on the tape and also a protective film (such as solder resist) is formed to cover the interconnecting pattern. The protective film is formed to expose a plurality of terminals of the interconnecting pattern, and a metal coating is formed by electroplating on the terminals. A plating lead that is connected electrically to the various leads of the interconnecting pattern is formed in the tape for electroplating. The plating lead is cut through by punching out part of the tape after the plating step is completed. In the prior art, the step of cutting through the plating lead includes previously forming an aperture portion in the protective film, to expose the plating lead, then punching through the tape on the inner side of the aperture portion.

However, since this involves separate steps of forming the aperture portion of the protective film and the hole in the tape, the plating lead could easily be exposed within the aperture portion of the protective film if the diameter of the hole in the tape is smaller than that of the aperture portion of the protective film. The portion of the plating lead that is exposed is connected electrically to the wiring, so there may be current leakage due to electromigration and the reliability of the wiring board may be lost.

### BRIEF SUMMARY OF THE INVENTION

According to a first aspect of the present invention, there is provided a method of fabricating a wiring board, comprising: forming a penetrating hole by punching out part of a region in a conductive pattern supported on a substrate, the region being covered by a protective film which is provided over the substrate, and the substrate and the protective film being punched out together with the part of the region.

According to a second aspect of the present invention, there is provided a wiring board, comprising:

a conductive pattern;

a substrate supporting the conductive pattern; and

a protective film formed on the substrate and partially covering the conductive pattern,

wherein an aperture is formed in each of the conductive pattern, the substrate, and the protective film to form a penetrating hole.

According to a third aspect of the present invention, there is provided a semiconductor device, comprising the above described wiring board-and a semiconductor chip mounted on the wiring board.

According to a fourth aspect of the present invention, there is provided an electronic instrument comprising the above described semiconductor device.

### BRIEF DESCRIPTION OF THE SEVERAL VIEWS OF THE DRAWING

FIGS. 1A and 1B are illustrative of a method of fabricating a wiring board in accordance with one embodiment of the present invention;

FIGS. 2A and 2B are further illustrative of the method of fabricating a wiring board in accordance with this embodiment;

FIG. 3 shows a method of fabricating a wiring board in accordance with a modification of this embodiment;

FIG. 4 shows a method of fabricating a wiring board in accordance with another modification of this embodiment;

FIG. 5 shows a semiconductor device in accordance with this embodiment;

FIG. 6 shows an electronic instrument in accordance with this embodiment; and

FIG. 7 shows another electronic instrument in accordance with this embodiment.

### DETAILED DESCRIPTION OF THE EMBODIMENTS

The present invention enables to restrict the exposure of a conductive pattern, thus improving the reliability of the wiring board.

(1) According to one embodiment of the present invention, there is provided a method of fabricating a wiring board, comprising: forming a penetrating hole by punching out part of a region in a conductive pattern supported on a substrate, the region being covered by a protective film which is provided over the substrate, and the substrate and the protective film being punched out together with the part of the region.

In this embodiment, a penetrating hole is formed in the wiring board by punching out part of the conductive pattern together with the substrate and the protective film. Therefore, the diameters of the holes in the protective film, the conductive pattern, and the substrate can be kept the same size in the axial direction of the penetrating hole. In other words, it is possible to prevent exposure of the conductive pattern on the inner side of the penetrating hole, as seen from a direction perpendicular to the substrate. It is therefore possible to increase the reliability of the wiring board.

(2) In this method of fabricating a wiring board,

the conductive pattern may include a plating lead covered by the protective film; and

part of the plating lead may be punched out in the step of forming the penetrating hole.

This makes it possible to prevent exposure of the plating lead within the penetrating hole.

(3) In this method of fabricating a wiring board,

the plating lead may have a branch portion that branches into at least two portions; and

the branch portion may be punched out in the step of forming the penetrating hole.

(4) In this method of fabricating a wiring board,

the protective film may have an aperture portion through which the conductive pattern is exposed;

the conductive pattern may have a terminal that is exposed from the aperture portion; and

a metal coating may be formed over the terminal by electroplating, before the step of forming the penetrating hole.

(5) The method of fabricating a wiring board may further comprise washing the wiring board after the step of forming the penetrating hole.

This makes it possible to remove fragments from the punched-out portion.

(6) According to one embodiment of the present invention, there is provided a wiring board, comprising:

a conductive pattern;

a substrate supporting the conductive pattern; and

a protective film formed on the substrate and partially covering the conductive pattern;

wherein an aperture is formed in each of the conductive pattern, the substrate, and the protective film to form a penetrating hole.

This embodiment of the present invention ensures that the diameters of the apertures in each of the protective film, the conductive pattern, and the substrate can be kept the same size in the axial direction of the penetrating hole. In other words, it is possible to prevent exposure of the conductive pattern on the inner side of the penetrating hole, as seen from a direction perpendicular to the substrate. It is therefore possible to increase the reliability of the wiring board.

(7) In this wiring board,

the conductive pattern may include a plating lead covered by the protective film; and

the penetrating hole may be formed to cut through the plating lead.

This makes it possible to prevent exposure of the plating lead within the penetrating hole.

(8) In this wiring board,

the plating lead may have at least two portions extending as far as the penetrating hole.

(9) In this wiring board,

an aperture portion through which the conductive pattern is exposed may be formed in the protective film;

the conductive pattern may have a terminal that is exposed from the aperture portion; and

a metal coating may be formed over the terminal.

(10) According to one embodiment of the present invention, there is provided a semiconductor device comprising the above described wiring board and a semiconductor chip mounted on the wiring board.

(11) According to one embodiment of the present invention, there is provided an electronic instrument comprising the above described semiconductor device.

In this method of fabricating a wiring board, the substrate may be a flexible substrate.

In this method of fabricating a wiring board, the protective film may be a solder resist.

In this method of fabricating a wiring board, the material of the protective film may be a polyimide resin.

Since a polyimide resin is flexible, this makes it possible to prevent splitting of the protective film in the step of forming the penetrating hole.

In this wiring board, the substrate may be a flexible substrate.

In this wiring board, the protective film may be a solder resist.

In this wiring board, the material of the protective film may be a polyimide resin.

An embodiment of the present invention is described below with reference to the accompanying figures. It should be noted, however, that the present invention is not limited in any way to this embodiment described below.

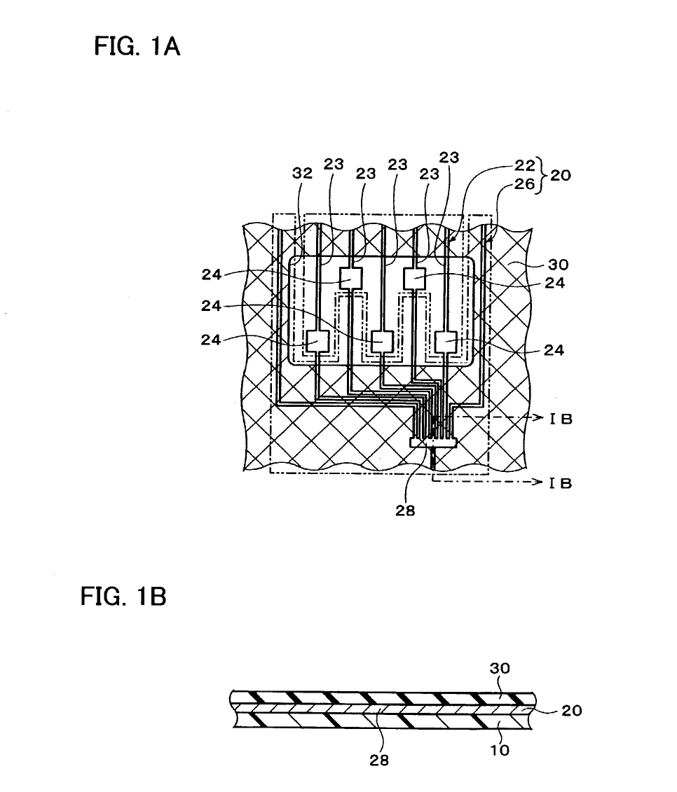

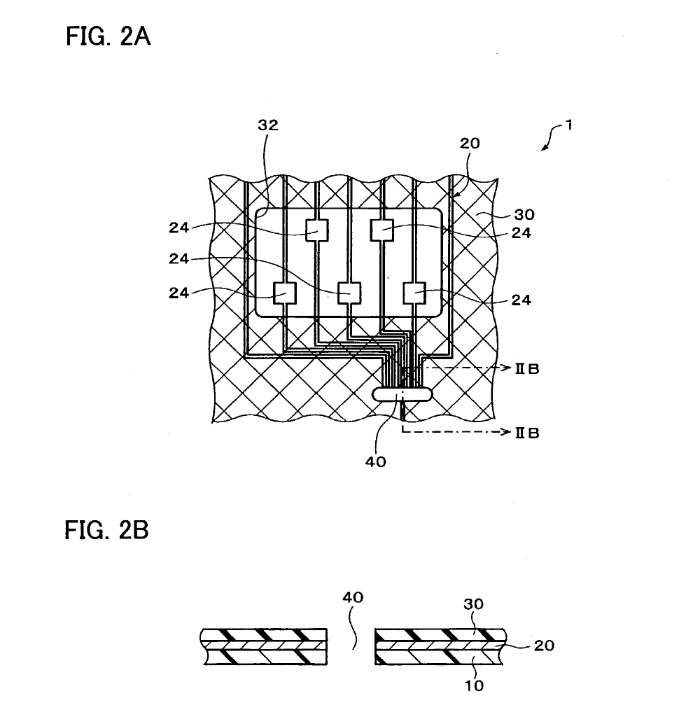

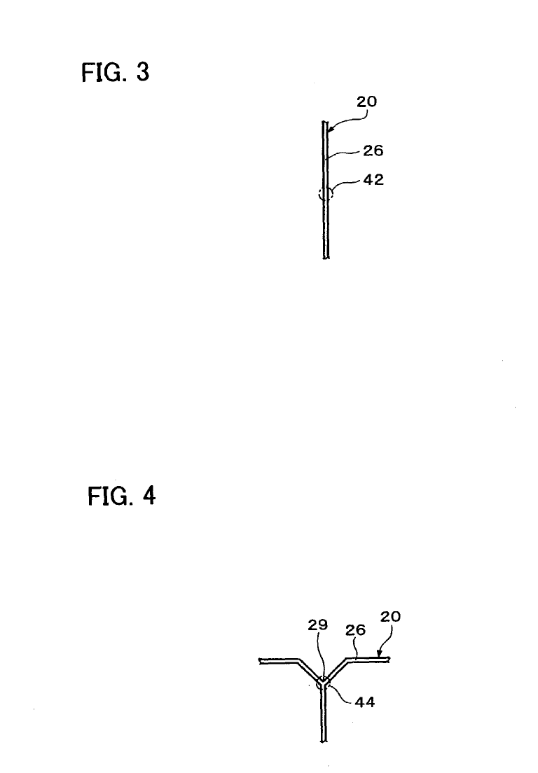

A method of fabricating a wiring board in accordance with this embodiment is shown in FIGS. 1A to 4. FIG. 1A is a partially enlarged view of a wiring board and FIG. 1B is a section taken along the line IB-IB of FIG. 1A. Similarly, FIG. 2A is a partially enlarged view of the wiring board and FIG. 2B is a section taken along the line IIB-IIB of FIG. 2A. FIGS. 3 and 4 are illustrative of modifications of this embodiment.

This embodiment is provided with a substrate 10, and a conductive pattern 20 and a protective film 30 are formed on the substrate 10.

The material of the substrate (base substrate) 10 is not restricted, and thus it could be organic (such as an epoxy substrate), inorganic (such as a ceramic substrate or glass substrate), or a composite thereof (such as a glass epoxy substrate). In the example shown in FIGS. 1A and 1B, the substrate 10 is a flexible substrate (such as a film or tape). Examples of such a flexible substrate include a polyester substrate or polyimide substrate, by way of example. The substrate 10 could also be a substrate for use in chip-on-film (COF) or tape automated bonding (TAB).

If the substrate 10 is a flexible substrate, it is preferable to fabricate a wiring board by a method using reel-to-reel transport. In such a case, the substrate 10 would have a long shape. Since this enables fabrication on a flow production line, it makes it possible to increase the manufacturing efficiency and reduce fabrication costs.

First of all, the conductive pattern 20 is formed on the substrate 10. A conductive foil of the material of the conductive pattern 20 is provided on a surface (such as one surface) of the substrate 10. The conductive foil could be attached to the substrate 10 with an adhesive material therebetween, to form a three-layer substrate. In such a case, the conductive pattern 20 could be formed by etching after photolithography. Alternatively, the conductive foil could be formed on the substrate 10 with no adhesive, to form a two-layer substrate. The conductive pattern 20 could be formed by a method such as sputtering, for example, or an additive method could be employed to form the conductive pattern 20 by electroless plating.

The conductive pattern 20 could be formed of a single layer (such as a copper layer) or it could be formed of a plurality of layers (such as a copper layer and a nickel layer). The conductive pattern 20 is a plurality of independently formed leads. A plurality of the conductive patterns 20 could be formed on the substrate 10. The conductive patterns 20 are supported by the substrate 10.

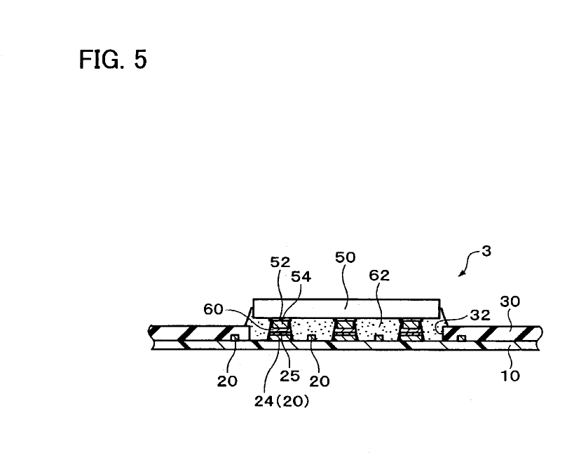

As shown in FIG. 1A, the conductive pattern 20 includes an interconnecting pattern 22 (the broken-line portion that includes leads 23) and a plating lead 26 (the broken-line portion that includes a branch portion 28). The interconnecting pattern 22 includes the plurality of leads 23 which provide electrical connection at least between two points, in a completed wiring board. Each the leads 23 has at least two terminals (including a terminal 24). Each terminal 24 is designed to be connected electrically to a semiconductor chip (see FIG. 5). The terminals 24 are exposed by an aperture portion 32 of the protective film 30. The terminals 24 are terminals for surface-mounting in the example shown FIG. 1A, but they could equally well be terminals having insertion holes for insertion-mounting. The terminals 24 could be lands (or pads), as shown in FIG. 1A. A land has a width that is greater than that of a line for supplying signals.

The plating lead 26 is connected electrically to the interconnecting pattern 22. This makes it possible to perform electroplating on the interconnecting pattern 22 (such as the terminals 24). In the example shown in FIG. 1A, all of the plating lead 26 is electrically connected.

The plating lead 26 has a branch portion 28 that has at least two branches. The branch portion 28 is a branch point where one line branches into a plurality of lines, from the plating lead 26. It is preferable that the branching is from one branch portion 28 to an unlimited number of lines, as shown in FIG. 1A. This makes it possible to reduce the number of branch portions 28 of the plating lead 26, thus reducing the number of portions of the plating lead 26 to be punched out. This therefore makes it possible to reduce the amount of labor required for punching out the plating lead 26. In the example shown in FIG. 1A, the branch portion 28 is wider than the lines. This makes it possible to extend a plurality of lines in the same direction from the branch portion 28.

The plating lead 26 is connected electrically to a plating electrode that is not shown in the figures. In other words, the conductive pattern 20 is connected electrically to the plating electrode. The plating electrode is formed to extend along both end portions of the rectangular substrate 10 (portions further out than the outer shape of the completed wiring board), extending in the longitudinal direction thereof. Since the inter connecting pattern 22 is connected to the plating electrode by the plating lead 26, it is sufficient to extend the leads 23 of the interconnecting pattern 22 as far as the plating electrode. The step of patterning the conductive pattern 20 can therefore be simplified without wasting any material of the conductive pattern 20.

The protective film 30 is then formed on the substrate 10. The protective film 30 is formed of a material have insulating properties (such as resin). The material of the protective film 30 could be a polyimide resin, by way of example. Since the polyimide resin is flexible (even more flexible than an epoxy resin, by way of example), it is possible to prevent splitting of the protective film 30 in a step of forming a penetrating hole, which will be described later.

As shown in FIGS. 1A and 1B, the protective film 30 is formed to cover part of the conductive pattern 20. More specifically, the protective film 30 is formed to cover the plating lead 26 and part of the interconnecting pattern 22 (a portion excluding the terminals 24). The protective film 30 could also be formed to cover a region in which the conductive pattern 20 is not formed, as shown in FIG. 1A. Note that the protective film 30 avoids the plating electrode and is formed on an inner side thereof.

The protective film 30 has the aperture portion 32. The aperture portion 32 exposes the plurality of terminals 24 of the interconnecting pattern 22. As shown in FIG. 1A, one aperture portion 32 could be used to expose a plurality of terminals 24. With this embodiment, the protective film 30 is a solder resist for selectively providing a soldering or brazing material. Since the protective film 30 will remain as part of the final product (wiring board), it is preferably selected from materials that have desired properties such as thermal resistance.

Note that a photolithography technique could be applied as the method of patterning the protective film 30 (the method of forming the aperture-portion 32), or another method such as printing or an ink-jet method could be used therefor.

The conductive pattern 20 is then subjected to electroplating. This forms a metal coating over the plurality of terminals 24 (see FIG. 5). The substrate 10 on which the conductive pattern 20 is formed is immersed in the plating liquid, a voltage that is lower than the voltage of an electrode in the plating liquid (not shown in the figure) is applied to the plating electrode, and a current flows between the electrode and the conductive pattern 20 within the plating liquid. Since the conductive pattern 20 is in electrical contact with the plating electrode and it is also electrically conductive in its entirety, the metal coating can be formed only on the portions exposed by the protective film 30.

A penetrating hole 40 is formed, as shown in FIGS. 2A and 2B, a penetrating hole 40. More specifically, the penetrating hole 40 is formed by simultaneously punching out a part of the conductive pattern 20 together with the substrate 10 and the protective film 30. In the example shown in the figures, the branch portion 28 of the plating lead 26 is punched out. In this case, the region including the branch portion 28 could be punched out, but there are no restrictions on the region that is punched out and the shape thereof, provided that the terminals 24 of the interconnecting pattern 22 are in an electrically independent state (not electrically conductive).

In the step of forming the penetrating hole 40, a connective portion (not shown in the figure) between the plating lead 26 and the plating electrode could also be punched out. The connective portion between the plating lead 26 and the plating electrode is exposed from the protective film 30. This makes it possible to punch out part of the plating lead 26 covered by the protective film 30, together with that connective portion that is exposed from the protective film 30. Therefore, it is not necessary to provide the conductive pattern 20 in a region exposed from the protective film 30, from consideration of the punching out after the plating step.

As a modification on the step of forming the penetrating hole, part of the plating lead 26 that extends in one direction covered by the protective film 30 could be punched out at a position denoted by reference number 42 in FIG. 3. This makes it possible to ensure that the terminal of the interconnecting pattern that is connected to one end portion of the plating lead 26 is made to be electrically independent of the terminal of the interconnecting pattern that is connected to the other end.

As another modification on the step of forming the penetrating hole, a branch portion 29 of the plating lead 26 that is covered by the protective film 30 could be punched out at a position denoted by reference number 44 in FIG. 4. The branch portion 29 is formed of a size such that a plurality of lines intersect. In the example shown in FIG. 4, one line branches into two lines extending in different directions from the start point of the branch portion 29. By punching out the branch portion 29, it becomes possible to make the terminals of the interconnecting pattern connected to the lines of the plating lead 26 electrically independent of each other.

In this manner, a wiring board 1 is fabricated, as shown in FIGS. 2A and 2B. The penetrating hole 40 is formed in the wiring board 1. The penetrating hole 40 passes through the protective film 30, the conductive pattern 20, and the substrate 10, as shown in FIG. 2B. The penetrating hole 40 is formed in such a manner that it has the same aperture diameter along the axial direction of the aperture. In other words, the conductive pattern 20 is not exposed on the inner side of the penetrating hole 40 shown in FIG. 2A, as seen from a direction perpendicular to the wiring board 1. The shape of the penetrating hole 40 is not particularly limited, and thus it could be the rectangular hole shown in FIG. 2A, or a round hole or a square hole.

Note that it is preferable to wash the wiring board 1 after the step of forming the penetrating hole 40. This makes it possible to remove fragments from the cut portions.

The method of fabricating a wiring board in accordance with this embodiment ensures that the penetrating hole 40 is formed in the wiring board 1 by punching out part of the conductive pattern 20 (specifically, part of the plating lead 26) together with the substrate 10 and the protective film 30. Therefore, the diameter of the hole in each of the protective film 30, the conductive pattern 20, and the substrate 10 can be made the same in the axial direction of the penetrating hole 40. In other words, it is possible to prevent exposure of the conductive pattern 20 on the inner side of the penetrating hole 40, as seen from a direction perpendicular to the wiring board 1. It is therefore possible to prevent the leakage of current due to migration, thus enabling an increase in the reliability of the wiring board.

A semiconductor device in accordance with this embodiment is shown in FIG. 5. A semiconductor device 3 includes the wiring board 1 and a semiconductor chip 50 mounted on the wiring board 1.

Integrated circuitry is formed in the semiconductor chip 50. The semiconductor chip 50 has pads 52, and a bump 54 is formed on each pad 52. The semiconductor chip 50 could be face-mounted on the wiring board 1. In such a case, the semiconductor chip is mounted face-down on the wiring board 1. Other electronic components (active components or passive components) could also be mounted on the wiring board 1. These electronic components could be peripheral components such as resistors, capacitors, or optical components, by way of example.

In the example shown in FIG. 5, the bumps 54 and the terminals 24 are connected electrically by a soldering or brazing material 60. Various methods could be used for connecting the bumps 54 and the terminals 24, such as another metal connection (such as a crimped connection between metals), or by a connection utilizing the shrink-hardening of an insulating resin, or by a connection by a conductive filler of an anisotropic conductive material. Note that a metal coating 25 generated by the above described electroplating is formed over the terminals 24.

Some resin 62 could be provided between the semiconductor chip 50 and the wiring board 1. The resin 62 is called an underfill material. The electrical connections between the bumps 54 and the terminals 24 are sealed by this resin 62.

The configuration and effects of the semiconductor device of this embodiment have already been discussed.

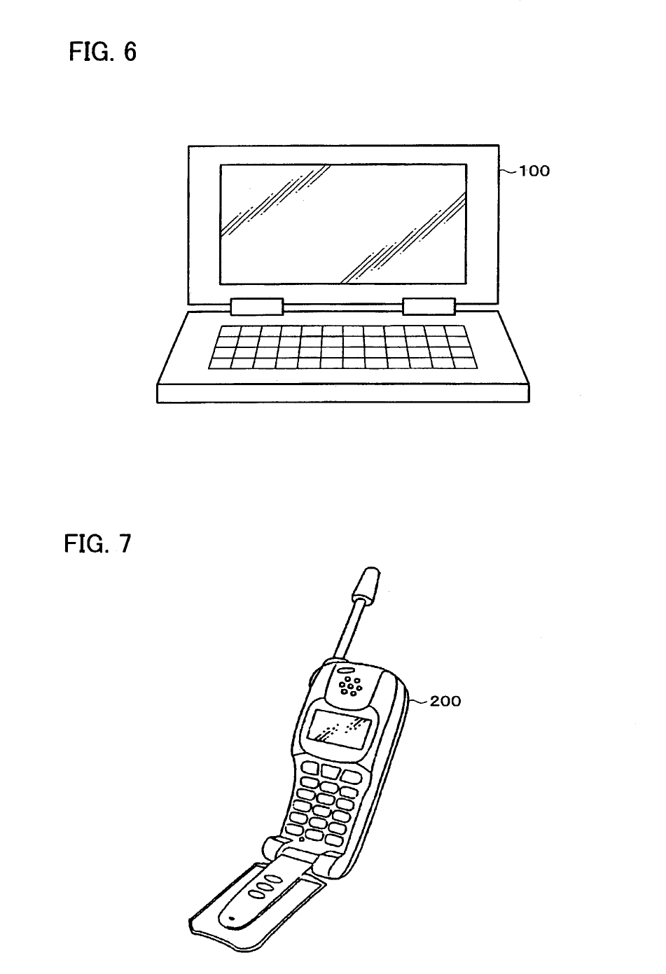

A notebook personal computer 100 shown in FIG. 6 and a portable phone 200 shown in FIG. 7 are examples of electronic instruments having the semiconductor device (or wiring board) in accordance with this embodiment of the present invention.

An electronic instrument in accordance with this embodiment could have an electro-optical device (not shown in the figure). A display panel (such as a glass substrate) of the electro-optical device is connected electrically to the semiconductor device 3. The electro-optical device is a liquid-crystal device, a plasma display device, an electroluminescent device, or the like, and has an electro-optical substance (such as a liquid crystal, discharge gas, or a light-emitting material).

The present invention is not limited to the above-described embodiment, and various modifications can be made. For example, the present invention includes various other configurations substantially the same as the configurations described in the embodiments (in function, method and effect, or in objective and effect, for example). The present invention also includes a configuration in which an unsubstantial portion in the described embodiments is replaced. The present invention also includes a configuration having the same effects as the configurations described in the embodiments, or a configuration able to achieve the same objective. Further, the present invention includes a configuration in which a publicly known technique is added to the configurations in the embodiments.

What is claimed is:

1. A method of fabricating a wiring board, comprising:
forming a penetrating hole by punching out part of a region in a conductive pattern supported on a substrate, the region being covered by a protective film which is provided over the substrate, and the substrate and the protective film being punched out together with the part of the region.

2. The method of fabricating a wiring board as defined in claim 1, wherein:
the conductive pattern includes a plating lead covered by the protective film; and
part of the plating lead is punched out in the step of forming the penetrating hole.

3. The method of fabricating a wiring board as defined in claim 2, wherein:
the plating lead has a branch portion that branches into at least two portions; and
the branch portion is punched out in the step of forming the penetrating hole.

4. The method of fabricating a wiring board as defined in claim 1, wherein:
the protective film has an aperture portion through which the conductive pattern is exposed;
the conductive pattern has a terminal that is exposed from the aperture portion; and
a metal coating is formed over the terminal by electroplating, before the step of forming the penetrating hole.

5. The method of fabricating a wiring board as defined in claim 2, wherein:
the protective film has an aperture portion through which the conductive pattern is exposed,
the conductive pattern has a terminal that is exposed from the aperture portion; and
a metal coating is formed over the terminal by electroplating, before the step of forming the penetrating hole.

6. The method of fabricating a wiring board as defined in claim 3, wherein:
the protective film has an aperture portion through which the conductive pattern is exposed,
the conductive pattern has a terminal that is exposed from the aperture portion; and
a metal coating is formed over the terminal by electroplating, before the step of forming the penetrating hole.

7. The method of fabricating a wiring board as defined in claim 1, further comprising:
washing the wiring board after the step of forming the penetrating hole.

8. A wiring board comprising:
a conductive pattern;
a substrate supporting the conductive pattern; and
a protective film formed on the substrate and partially covering the conductive pattern;
wherein an aperture is formed in each of the conductive pattern, the substrate, and the protective film to form a penetrating hole.

9. The wiring board as defined in claim 8, wherein:
the conductive pattern includes a plating lead covered by the protective film; and
the penetrating hole is formed to cut through the plating lead.

10. The wiring board as defined in claim 9,
wherein the plating lead has at least two portions extending as far as the penetrating hole.

11. The wiring board as defined in claim 10,
wherein the plating lead has at least two portions extending as far as the penetrating hole.

12. The wiring board as defined in claim 8, wherein:
an aperture portion through which the conductive pattern is exposed is formed in the protective film;
the conductive pattern has a terminal that is exposed from the aperture portion; and
a metal coating is formed over the terminal.

13. The wiring board as defined in claim 9, wherein:
an aperture portion through which the conductive pattern is exposed is formed in the protective film;
the conductive pattern has a terminal that is exposed from the aperture portion; and
a metal coating is formed over the terminal.

14. The wiring board as defined in claim 10, wherein:
an aperture portion through which the conductive pattern is exposed is formed in the protective film;
the conductive pattern has a terminal that is exposed from the aperture portion; and
a metal coating is formed over the terminal.

15. A semiconductor device comprising:
a wiring board including: a conductive pattern; a substrate supporting the conductive pattern; and a protective film formed on the substrate and partially covering the conductive pattern, wherein an aperture is formed in each of the conductive pattern, the substrate, and the protective film to form a penetrating hole;. and
a semiconductor chip mounted on the wiring board.

16. The semiconductor device as defined in claim 15, wherein:
the conductive pattern includes a plating lead covered by the protective film; and
the penetrating hole is formed to cut through the plating lead.

17. The semiconductor device as defined in claim 16,
wherein the plating lead has at least two portions extending as far as the penetrating hole.

18. An electronic instrument comprising a semiconductor device which has:
a wiring board including: a conductive pattern; a substrate supporting the conductive pattern; and a protective film formed on the substrate and partially covering the conductive pattern, wherein an aperture is formed in each of the conductive pattern, the substrate, and the protective film to form a penetrating hole; and
a semiconductor chip mounted on the wiring board.

19. The electronic instrument as defined in claim 18, wherein:
the conductive pattern includes a plating lead covered by the protective film; and
the penetrating hole is formed to cut through the plating lead.

20. The electronic instrument as defined in claim 19,
wherein the plating lead has at least two portions extending as far as the penetrating hole.
